(19) United States
(12) Patent Application Publication
(10) Pub. No.: US 2011/0191001 A1
(43) Pub. Date: Aug. 4, 2011

(54) Device For Monitoring The Correct Functioning Of A Crop Pick-Up Mechanism

(76) Inventor: Jean Viaud, Reyssouze (FR)

(21) Appl. No.: 12/849,362

(22) Filed: Aug. 3, 2010

(30) Foreign Application Priority Data
Aug. 4, 2009 (DE) 10 2009 028 227.0

(51) Int. Cl. A01D 43/06; G06F 7/00; B06B 1/00; G06F 15/00; G08B 23/00

(52) U.S. Cl. 701/99; 56/341; 367/140; 702/182; 340/425.5

(57) ABSTRACT

A device is provided for monitoring the correct functioning of a crop pick-up mechanism. The device features a sensor that monitors the crop pick-up mechanism and/or a region situated in front thereof referred to the forward moving direction. The sensor is connected to a signal processing device that derives information on crop accumulations upstream of the crop pick-up mechanism that do not occur during proper operation from the signals of the sensor and generates an error signal in case of a crop accumulation.

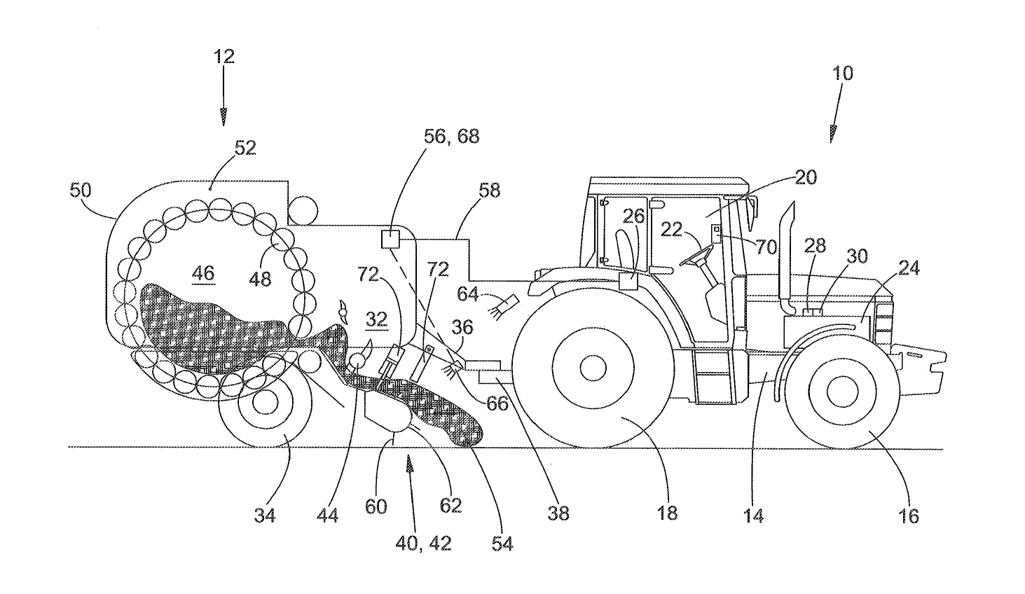

### FIELD OF THE INVENTION

The invention pertains to a device for monitoring the correct functioning of a crop pick-up mechanism, featuring a sensor that monitors the crop pick-up mechanism and/or a region situated in front thereof with reference to the forward moving direction and is connected to a signal processing unit.

### BACKGROUND OF THE INVENTION

With agricultural harvesting machines that pick up crop from a field, there is a risk of picking up excessive crop quantities all at once, leading to congestion in the harvesting machine. In other operating situations, the crop pick-up mechanism may not correctly pick up the crop, but rather push it in front of itself. With self-propelled harvesting machines such as combine-harvesters or forage harvesters, the correct operation of the crop pick-up is actively monitored by the operator who has a good overview from his/her work station. With forage boxes and balers that are towed behind a towing vehicle and pick up the crop with crop pick-up mechanisms, the operator must turn around from time to time in order to inspect the crop pick-up mechanism through the rear window of the cabin of the towing vehicle, if applicable, and to check whether the crop has been correctly picked up. These rear inspections are relatively strenuous in the long term and can lead to undesirable deviations from a driving path that extends over a windrow.

In order to prevent damage to the harvesting machine due to crop congestion, it is known to utilize overload clutches and sensors for determining the torque in the drive train of the in-feed conveyor, wherein said overload clutches and sensors shut down the drive train in case of an overload (see for example German Patent Documents DE 199 18 552 A1 and DE 102 41 216 A1). However, these overload clutches and sensors can only become effective once crop congestion has already occurred in the harvesting machine and provide no assistance in monitoring correct crop pick-up by the pick-up mechanism.

Also known are video monitoring systems with cameras and monitors arranged at the operator work station, wherein the monitor may be arranged, for example, on the cabin roof of a tractor in order to monitor the operation of the crop pick-up mechanism of a forage box (the magazine Profi 2/2007, pp. 64-67). Although the operator no longer needs to continuously turn around in order to monitor the functioning of the crop pick-up mechanism in this case, he must focus his attention on the monitor instead.

It has also been proposed to arrange cameras that optically monitor the crop flow at different locations of harvesting machines. According to German Patent Document DE 10 2005 005 557 A1, a camera on a forage, box monitors the crop being picked up and transported into the forage box and is connected to an image processing system that, in turn, automatically controls functions of the forage box such as, e.g., the speed of the scraper floor drive. U.S. Pat. No. 6,119,442 A1 describes a combine-harvester with cameras that are arranged at different locations and connected to image processing systems that control adjustments of the harvesting machine. One camera is pointed at the front in order to detect the quantity of crop being picked up that, in turn, is used for adjusting the driving speed, the thresher rotor speed, the speed of the internal combustion engine, the speed of the reaping device and the slope conveyor speed. According to German Patent Document DE 10 2004 039 462 A1, the driving speed of a forage harvester is analogously controlled based on the signal of a camera that detects the quantity of the crop situated in front of the forage harvester. According to these documents, the camera signal serves for controlling functions of the harvesting machine, but not for monitoring correct crop pick-up.

The problem to be solved with the invention consists of simplifying the monitoring of the correct functioning of a crop pick-up mechanism for the operator of a harvesting machine.

### SUMMARY OF THE INVENTION

A device for monitoring the correct functioning of a crop pick-up mechanism comprises a sensor that monitors the crop pick-up mechanism and/or a region situated in front thereof with reference to the forward moving direction and generates a signal, from which information can be derived that indicates whether crop accumulations that do not occur during proper operation have formed on the crop pick-up mechanism. The sensor is connected to a signal processing device that is able to derive information indicating whether the aforementioned crop accumulations are being formed from the signals of the sensor. In this case, the signal processing device generates an error signal that can be optically and/or acoustically announced to the operator and/or causes the harvesting machine to stop automatically.

Due to these measures, the operator is relieved from the task of monitoring the crop pick-up mechanism such that his work is significantly simplified.

In case an undesirable crop accumulation occurs, this accumulation can be easily cleared by the operator (or automatically) by raising the crop pick-up mechanism such that it moves over the crop remaining on the ground or by moving the harvesting machine with the crop pick-up mechanism back such that the crop separates from the crop pick-up mechanism and can be picked up without any problems during a second pass. This prevents more significant problems caused by the accumulated crop, for example, if the accumulated crop separates, is picked up by the harvesting machine in the form of bundles or clumps and causes a crop congestion in the harvesting machine that needs to be laboriously cleared. Consequently, the productivity of the harvesting machine is improved.

It should be noted that a suitably designed signal processing device is also able to detect whether larger crop accumulations are approaching the crop pick-up mechanism (or vice versa) based on the signals of the sensor such that an error signal can also be generated in this case in order to prevent clogging of the crop pick-up mechanism in an anticipatory fashion.

The present invention is particularly suitable for crop pick-up mechanisms in the form of conventional crop pick-ups used on combine-harvesters, forage harvesters, balers or forage boxes that may be respectively moved by a vehicle or realized in a self-propelled fashion.

The signal processing device preferably detects crop accumulations being pushed in front by the crop pick-up mechanism, for example, on its outer ends and do not occur during proper operation, based on the signals of the sensor.

Since the crop accumulations consist of part of the crop that does not move relative to the crop pick-up mechanism, but relative to the ground, the movement can serve as a criterion for an undesirable crop accumulation for the signal processing device.

In one simple embodiment, a mechanical probe that scans a region in front of the crop pick-up mechanism may be considered as a sensor. Alternatively or additionally, an ultrasonic sensor that scans the aforementioned region can be used. Furthermore, an optical sensor may be utilized, for example, in the form of a two-dimensional or three-dimensional camera that is pointed at a region in front of the crop pick-up mechanism or a laser distance measuring device that scans the region in front of the crop pick-up mechanism.

### BRIEF DESCRIPTION OF THE DRAWINGS

An exemplary embodiment of the invention is described in greater detail below with reference to the single drawing figure wherein:

The FIGURE is a schematic side view of a combination of a vehicle in the form of a tractor and a harvesting machine in the form of a round baler, the crop pick-up mechanism of which is equipped with a device for monitoring its correct functioning.

### DESCRIPTION OF THE PREFERRED EMBODIMENT

The combination shown consists of a towing vehicle 10 in the form of a tractor and a harvesting machine 12 in the form of a round baler. The towing vehicle 10 comprises an undercarriage 14 that is equipped with a frame and supported on the ground by means of steerable front wheels 16 and driven rear wheels 18. A cabin 20 with an operator work station featuring a seat (not shown) and a steering wheel 22, as well as an internal combustion engine 24, are mounted on the undercarriage 14. The crankshaft of the internal combustion engine 24 is connected to a power take-off gear that, in turn, drives the harvesting machine 12 via a power take-off shaft. An electronic control unit 26 is electrically connected to an engine control 28 that controls and adjusts the operating parameters of the internal combustion engine 24 and to a propulsion control 30 of the towing vehicle 10. The internal combustion engine 24 also drives the wheels 18 and, if applicable, 16 via another gear (not shown).

The harvesting machine 12 comprises an undercarriage 32 that is supported on the ground by means of wheels 34 and connected to a hitch 38 of the towing vehicle 10 by means of a drawbar 36. The harvesting machine 12 comprises a crop pick-up mechanism 40 in the form of a crop pick-up 42 that is also referred to as a pick-up, wherein this crop pick-up mechanism transports the crop lying on the field in an overshot fashion and delivers the crop to a rotor 44 for transporting the crop into a baler chamber 46. The baler chamber 46 is sealed by rollers 48. A back door 50 that can be pivoted rearward and upward is provided in the rear region of the harvesting machine 12 and hinged to the upper side of the undercarriage 32 about an axis 52 that extends horizontally and transverse to the forward direction in order to eject a finished bale. The rollers 48, the rotor 44 and the crop pick-up 42 are connected to and driven by the output of the power take-off shaft of the towing vehicle 10 via a drive shaft. An electronic control unit 56 of the harvesting machine 12 is connected to actuators and sensors of the harvesting machine 12 and communicates with the control unit 26 of the towing vehicle 10 via a bus 58.

During harvesting, the crop pick-up 42 transports the crop 54 that lies on a field and usually was left as a windrow into the harvesting machine 12 with its tines 60 that are conventionally mounted on a rotating rotor and extend through the intermediate spaces between stripping plates 62. Under certain circumstances, however, it may occur that the tines 60 of the crop pick-up 42 do not take hold of the entire crop such that crop accumulations are formed upstream of the crop pick-up 42 as shown in the FIGURE. Such crop accumulations frequently form on the lateral ends of the crop pick-up 42. In order to prevent such crop accumulations and their undesirable consequences (crop losses if the crop accumulation separates and laterally moves past the crop pick-up 42 or crop congestions in the harvesting machine 12 if the crop accumulation is picked up by the crop pick-up 42 all at once in the form of bundles or clumps), the operator in the cabin 20 has had, in the past, to regularly turn around in order to monitor the crop pick-up 42 with respect to its correct functioning or a camera 64 was mounted on the rear side of the towing vehicle 10 or on the drawbar 36 and the operator was able to watch the camera image on a monitor in the cabin 20. Both alternatives distract the operator from his actual duty of steering the towing vehicle 10 and monitoring the function of the harvesting machine 12.

According to the present invention, at least one sensor 64, 66, 72 is provided that monitors the crop pick-up 42 and the region that lies in front of the crop pick-up 42 with reference to the forward moving direction of the towing vehicle 10 that extends toward the right in the FIGURE. In the embodiment shown, the sensor 64 is realized in the form of a two-dimensional or three-dimensional camera and the sensor 66 consists of an ultrasonic distance sensor. The sensor 64 is mounted on the rear side of the towing vehicle 10, for example, on a fender or on the cabin 20, particularly on its roof. The sensor 66 is mounted on the drawbar 36 of the harvesting machine 12 in the embodiment shown. The sensor 72 consists of a mechanical probe that is suspended in pendulum fashion on its upper side about an axis that extends horizontally and transverse to the forward moving direction and the angle of which about the pendulum axis is detected.

The sensors 64, 66, 72 are connected to the control unit 56 that also serves as a signal processing device 68 for processing the signals of the sensors 64, 66, 72 via the bus 58 or separate lines. In harvesting mode, the signal processing device 68 processes the signals of the sensors 64, 66, 72 and derives information indicating whether the described crop accumulation has formed upstream of the crop pick-up 42 thereof. Such a crop accumulation can be detected, for example, when the sensor 66 measures a distance that is smaller than a certain threshold value. Such a crop accumulation can also be detected when the crop pick-up 42 in the image of the sensor 64 pushes a crop quantity in front of itself that exceeds a certain size (surface or volume), wherein this can be detected by means of an image processing program running on the signal processing device 68 based on the identifiable positions of the crop pick-up 42 shown in the image and the crop that does not move relative to the crop pick-up 42. With respect to the sensor 72, a crop accumulation can be detected when the angle about the pendulum axis exceeds a predetermined value.

Alternatively (or additionally) to the described sensor types, it is also possible to use one-dimensional or two-dimensional scanning laser distance measuring devices that detect the height and preferably also the horizontal extent of the crop accumulating on the front side of the crop pick-up 42 in the forward moving direction, wherein an error signal is generated if the height and/or horizontal extent of the crop exceeds a predetermined threshold value.

Once the signal processing device 68 has identified a crop accumulation on the crop pick-up 42 that does not occur during the proper operation, it transmits an error signal to the control unit 26 of the towing vehicle 10 via the bus 58. The control unit of the towing vehicle generates an acoustical and an optical warning signal by means of an operator display unit 70 arranged at the operator work station in order to inform the operator of the crop accumulation. In addition, the control unit 26 causes the propulsion control 30 to stop the towing vehicle 10. The operator can then dismount the vehicle and manually clear the crop accumulation. In an advanced embodiment, the signal processing device 68 may also cause an actuator 72 to raise the crop pick-up 42 by means of the control device 56 such that it simply drives over the crop accumulation or to move the towing vehicle 10 back by a certain distance by means of the bus 58 and the control 26 in order to pick up the crop accumulation by means of the crop pick-up 42 during a second pass.

Consequently, the sensors 64 and/or 66 and the signal processing device 68 make it possible to automatically detect a crop accumulation on the front side of the crop pick-up 42 such that the work of the operator is significantly simplified.

Having described the preferred embodiment, it will become apparent that various modifications can be made without departing from the scope of the invention as defined in the accompanying claims.

The invention claimed is:

1. A device for monitoring the correct functioning of a crop pick-up mechanism, the device comprising a sensor that monitors at least one of the crop pick-up mechanism and a region situated in front thereof referred to the forward moving direction and is connected to a signal processing device, wherein the signal processing device derives information on crop accumulations upstream of the crop pick-up mechanism that do not occur during proper operation from the signals of the sensor and generates an error signal in case of a crop accumulation.

2. The device according to claim 1, wherein the signal processing device is connected to a warning device that at least one of acoustically and optically informs an operator of a vehicle of a crop accumulation when an error signal is generated.

3. The device according to claim 1, wherein the signal processing device is connected to a propulsion control of a vehicle that causes the vehicle to stop when an error signal is generated.

4. The device according to claim 1, wherein the device automatically clears the accumulated crop, by at least one of raising and moving back the crop pick-up mechanism.

5. The device according to claim 1, wherein the signal processing device detects crop accumulations being pushed in front of the crop pick-up mechanism, and generates, if applicable, the error signal based on the signals of the sensor.

6. The device according to claim 1, wherein the signal processing device detects a part of the crop that does not move relative to the crop pick-up mechanism as a crop accumulation.

7. The device according to claim 1, wherein the sensor comprises a mechanical probe that scans a region in front of the crop pick-up mechanism.

8. The device according to claim 1, wherein the sensor comprises an ultrasonic sensor that interacts with a region in front of the crop pick-up mechanism.

9. The device according to claim 1, wherein the sensor comprises at least one of an optical sensor that points at a region in front of the crop pick-up mechanism and a laser distance measuring device that scans the region in front of the crop pick-up mechanism.

10. The device according to claim 1, wherein the signal processing device generates an error signal if at least one of the height and horizontal extent of the crop in the forward moving direction detected by the sensor exceeds a predetermined threshold value.

11. The device according to claim 1, wherein the crop pick-up mechanism is a crop pick-up.

12. The device according to claim 11, wherein the harvesting machine is one of a combine-harvester, a forage harvester, a baler and a forage box.
